(19) United States
(12) Patent Application Publication
(10) Pub. No.: US 2026/0257427 A1
(43) Pub. Date: Sep. 3, 2026

(54) FABRICATION AND INSPECTION OF NON-TAMPERABLE MANUFACTURED COMPONENTS

(71) Applicant: Bundesrepublik Deutschland, vertreten durch den Bundesminister für Wirtschaft und Klimaschuts, Berlin (DE)

(72) Inventors: Anja WASKE, Dresden (DE); Stefan HOHENDORF, Potsdam (DE); Jens GÜNSTER, Berlin (DE)

(73) Assignee: Bundesrepublik Deutschland, vertreten durch den Bundesminister für Wirtschaft und Klimaschutz, Berlin (DE)

(21) Appl. No.: 18/993,241

(22) PCT Filed: Jul. 12, 2023
(86) PCT No.: PCT/EP2023/069388

§ 371 Date: Jan. 10, 2025

(30) Foreign Application Priority Data
Jul. 13, 2022 (EP) 22184750.2

(51) Int. Cl. B29C 64/393; B29C 64/188; B33Y 10/00

(52) U.S. Cl. CPC B29C 64/393; B29C 64/188; B33Y 10/00

(57) ABSTRACT

A method (1000) for generating a digital object identifier (100, 110, 120) of a component (c) is provided. The method includes obtaining digital image data of the component (c), wherein the component (c) is produced by an additive manufacturing process; identifying a microfeature (f) within the component (c) in the digital image data of the component (c); determining a coordinate, comprising x, y and/or z; and generating the digital object identifier (100) of the component (c) by indicating the coordinate (x, y and or z) of the identified microfeature (f).

### TECHNICAL FIELD

The present invention relates to fabricating and inspecting of components such as machine parts, in particular with respect to additive manufacturing techniques.

In all the world's research laboratories, it is imperative to label samples and parts under investigation unambiguously so that no mix-ups can occur. This applies all the more to industrial companies, especially those producing components or products for safety-relevant sectors (e.g. the aviation industry, the military, and the automotive industry). The elaborate documentation of all manufacturing and processing steps is pointless if the wrong physical component or sample is accidentally or even intentionally assigned to these digital data.

Therefore, a one-to-one, non-destructive, non-tamperable component identification is required, which allows a one-to-one assignment between a physical component and digital data thereof during the whole manufacturing process of a given product and during its lifetime, i.e. in use and/or in storage.

### SUMMARY OF THE INVENTION

According to an embodiment, a fabrication process includes manufacturing a component, (non-destructively) detecting salient microfeatures of the component, and generating a (primary) digital object identifier (DOI) of the manufactured component based on the detected salient microfeatures.

According to an embodiment, an (a corresponding) inspection process includes non-destructively detecting salient microfeatures of a manufactured component, and checking an authenticity of the manufactured component based on the non-destructively detected salient microfeatures and a (primary) digital object identifier of the manufactured component.

Accordingly, non-tamperable component fabrication and inspection (identification) can be provided. This may also facilitate further processing or use of the component. In particular, it can be ensured that only authorised components are further processed and used, respectively.

Advantageously, the internal structure of the typically additively manufactured component can be studied using 3D imaging methods, e.g. computed tomography (CT), which reveal in great detail even small defects, irregularities or artefacts, e.g. pores, inclusions, density variations, as well as small variations in geometry. Such structural and/or compositional microfeatures can be listed in form of a table that forms a unique digital object identifier DOI for each component. The characters in the table have typically a standardized format. The signs and characters comprising the suggested DOI can favourably be selected from, for instance, ISO8859-1 graphic character set. In order to further compress the data of structural and/or compositional microfeatures, the table comprising them, is translated into, e.g., a binary number string (001010 . . . ) or an alphanumeric string which is unique to the particular component as well. By using a suitable and openly accessible software this string is further converted into another compressed format, e.g. a quick response (QR) code. The QR code allows for compact visualization of the table and good machine readability of the component's digital identifier. Said QR code is physically attached to the component or can be printed on a surface thereof which is not subject to wear. A permanent “attachment” of the chosen digital object identifier can be reached, e.g., by electrochemical labelling or etching, direct laser writing, dot peening or similar techniques.

It is important to note that the sum of the above structural features, collectively called herein microfeatures, is individual for each component and therefore suitable to achieve one-to-one identification. Even if a series of components (e.g. a lot) is produced with the same additive manufacturing apparatus and applying identical processing parameters, these components will be discernible by their DOI. On the one hand, it is impossible to reproduce or implement the individually observed microfeature pattern of one component for another component. On the other hand, it is impossible to subsequently manipulate the microfeature pattern. Therefore, the proposed digital object identifier generated on the basis of the individual microfeature pattern cannot be falsified and cannot be manipulated, i.e. it is tamper-proof.

The technique suggested herein for creating a DOI of a component or sample does not possess the indicated drawbacks: Similar to facial or fingerprint recognition, object-specific micro scaled or sub micro scaled features, collectively called herein microfeatures, can be extracted from a complex 3D or even 2D data set, such as a photograph or scan of a component, to create a digital fingerprint of the component. This data can then be stored in an abbreviated and/or encrypted form as a digital object identifier—DOI.

Analogous to a digital fingerprint, a DOI based on a CAD file or, for example, based on a comparison of different CAD files relating to a single component, can be used for a unique component description and/or component identification and/or an authentication of a component declared as an “original” component. By the term “original” is meant a component manufactured under a particular label or brand or by a particular manufacturer. Such a manufacturer may be, for example, a certified manufacturer whose production process complies with a specific standard, such as an ISO standard, or any other international or national standard. The advantages are obvious and relate to various application areas in the real technical world.

The occurrence of the mentioned small defects, irregularities or artifacts, e.g. pores, inclusions, density variations, especially inhomogeneities, voids and/or pores of an additively manufactured component, which will be referred to as salient micro features in the following, can be induced by some basic processes

For example, in scanning (hatching), to fill areas of the 2-dimensional layer information of a component, adjacent laser tracks during manufacturing the component may result in a local overheating, especially near the turning points of a laser at the end of a track, which is associated to the boundary of the parts 2-dimensional contour. This type of defect (salient microfeature) is, therefore, likely to be found near the boundary of the components 2-dimensional contour. In this regard it is noted that during manufacturing not only the melting conditions (energy input per volume of the laser or another energy beam), but also the manufacturing time and/or manufacturing efficiency (time/effort for laser repositioning and “laser-on” time) is typically optimized. Thus, respective salient microfeatures are typically formed during (additively) manufacturing.

Generally, for components that are (additively) manufactured by local heating of a powder bed, i.e. a feedstock powder, or a binder thereof, for example using an energy beam, such as a light beam, particularly a laser beam or an electron beam, deviations from ideal melting condition can be caused:
1) at locations where the local energy density during the build process deviates significantly from an optimal energy density required to build a dense component.

In particular,
(1a) excessive local energy density can lead to an extending melt pool and in some cases even local vaporization of material (metal, polymer, ceramic), balling phenomena, and high thermal stress cracking [cf. Peng, T., Chen, C. (2018) Influence of energy density on energy demand and porosity of 316L stainless steel fabricated by selective laser melting. Int. J. of Precis. Eng. and Manuf.-Green Tech. 5, 55-62 (2018). https://doi.org/10.1007/s40684-018-0006-9].

These locations are thus predefined by an above-average input value of the laser energy, e.g., at reversal points (inflection or turn points) of the beam near an inner or outer surface of the component due to an increased energy input of the laser (or E-beam) during reversal and/or a temporarily increased laser energy (fluctuations in the stability of the laser) or due to a below-average local velocity, i.e., a decreased rate of progress of the laser or electron beam.

A too high local energy density can also be caused by the laser pushing a “heat wave” in front of it. If the laser runs against a boundary surface of the component (contour line), the heat can no longer be dissipated in the component by thermal conduction, because no or less thermal conduction takes place and only thermal radiation remains. This situation is, of course, exacerbated if the laser reverses and crosses over again in the other direction at a reversal or turning point.

Alternatively,
(1b) insufficient local energy density may lead to unmolten powder and thus to voids/pores; [cf. H. Gu, H. Gong, D. Pal, K. Rafi, T. Starr, B. Stucker (2013) Influences of energy density on porosity and microstructure of selective laser melted 17-4 PH stainless steel. (as available via https://repositories.lib.utexas.edu/bitstream/handle/2152/88638/2013-37-Gu.pdf]

These locations are defined by below-average energy density of the laser, e.g., below-average local laser energy in the powder bed of component under construction), or above-average local velocity of the laser spot.

Further, salient microfeatures can also be caused
2) if the additive manufacturing process requires an inert gas atmosphere.

The inert gas typically flows as a directed stream around or against the powder bed or “growing” component and a surface thereof. In the process, the powder bed, i.e. the component under construction, may no longer be completely covered by the inert gas at an edge or contour line thereof, if the inert gas flow breaks off just at the edge, i.e. at the contour line. This can have the consequence that—in the presence of atmospheric oxygen—oxidation processes start in the temporarily melted material, i.e. the melt pool. This is apparently relevant for direct energy deposition processes such as DED arc, also known as Wire Arc Additive Manufacturing (WAAM).

Beside the discussed above process parameters such as “energy input/energy density (energy input per volume)”, spot/focus size, spot/focus velocity, as well as dwell time at turn points, powder bed (component) shape etc., specific material properties such as particle size, powder bed density, convection phenomena in the melt pool, viscosity of the melt, size of the melt pool etc. influence the occurrence of the salient microfeatures within the component.

While the salient micro features are considered natural variations, they are not statistically uniformly distributed throughout the component, but occur predominantly where optimal (ideal) melting/curing conditions did not exist. This is the case either for incomplete melting under the conditions as described in [0017], for which the porous space found between the feedstock particles partly remains inside of the 3D manufactured components. On the other hand, deviation from ideal melting conditions can occur by overheating, i.e. by introducing significantly more energy per volume than needed for the phase transition from solid to liquid material as described above, leading to excessive evaporation, bubbling and splattering of the melt pool, which creates pores and defects by incorporating air bubbles during solidification. In contrast, under ideal melting conditions, the feedstock powder fully melts, but overheating is avoided.

Since the majority of pores in a component is located at regions in which melt conditions are not ideal, and these regions typically make up only a fraction of the entire part, the search for salient microstructures can be limited to these regions, making the search process efficient and fast. For the reasons given in [0014] to [0016], non-ideal melting conditions for the overheating case are typically found close to inner and/or outer surfaces of the part, because heat can accumulate between successive neighboring laser heat inputs.

With this in mind, it is proposed to specifically search for salient microfeatures (1) in the vicinity of crossing points, reversal points or turning points of the guided energy beam (laser or E-beam) and/or (2) in the vicinity of outer or inner contour lines of the component in question.

This has the advantage that with a minimum of measurement time (cost) a sufficient number of salient micro features can be detected and a DOI based thereon can be created to unambiguously describe any component using the DOI before it is brought to market. The DOI determined for each component is stored in a database, e.g. a digital product passport. The manufacturer is thus able to recognize all the components he has ever manufactured.

The term “DOI” as used herein intends to describe a persistent identifier or fingerprint that can be used to uniquely identify a (real, manufactured) component (c). The DOI may be determined based on and/or comprise the coordinates of at least a subset of the identified microfeatures and/or may represent or be provided by a respective 3D dataset of the detected salient microfeatures or the subset thereof, in particular a 3D point cloud of the detected salient microfeatures or the subset thereof. The DOI may be determined based on, represented by and/or provided by 2D-tomograms of the component (c), the 2D-tomograms representing the salient microfeatures and typically being determined during or after manufacturing the component (c), or a respective 3D-tomogram.

Advantageously, the DOI can be used, e.g., for tamper-proof identification of the component before a contractual service (warranty claim of the customer), maintenance or liability-relevant repair is carried out.

The DOI, i.e. its absence from the database, can also be used to identify components manufactured on the same device without authorization for which no DOI has been recorded (unauthenticated components).

The regions affected by overheating are best described by using the hatch distance as a measurement unit. The hatch distance describes the separation between two consecutive laser beams and is, depending on the laser and powder size used, typically on the order of 50-300 micrometer (μm). The region affected by overheating can be estimated to be smaller than 5× hatch distance from the turning/inflection point or from the surface point at which the laser exits the component, e.g. a feedstock powder of the component under construction.

According to an embodiment a fabrication process is suggested, comprising manufacturing a component; detecting salient microfeatures of the component, and generating a digital object identifier (DOI), of the manufactured component based on the detected salient microfeatures.

According to an embodiment, an inspection process is suggested, comprising non-destructively detecting salient microfeatures of the manufactured component; checking an authenticity of the manufactured component based on the non-destructively detected salient microfeatures and a primary digital object identifier, DOI, of the manufactured component. The primary digital object identifier, i.e. the primary DOI, is typically a pre-determined (pre-existing) DOI generated during manufacturing the component, whose generation is described further below in detail.

According to an embodiment, a process for restoring of a functionality of a component is suggested. The process comprises: performing an inspection process as explained herein, and, if the authenticity is established (verified), i.e. if the checking of the authenticity of the manufactured component has been/is successful, which is typically done based on the DOI, at least one of: performing the inspection process, and, if authenticity is established, at least one of: using the component; repairing the component; refurbishing the component; servicing the component; and recycling the component.

According to an embodiment, a system is suggested. The system comprises: a detection sub-system for non-destructively detecting salient microfeatures during manufacturing a component and/or of the manufactured component; and a control unit functionally connected with the detection sub-system. The control unit is configured for at least one of: checking an authenticity of the manufactured component based on the non-destructively detected salient microfeatures and a digital object identifier (DOI) of the manufactured component, wherein the DOI refers to salient microfeatures of the manufactured component, and generating a DOI representing a plurality of the non-destructively detected salient microfeatures.

Thus, according to an embodiment a fabrication process is suggested, comprising manufacturing a component, detecting salient microfeatures of the component, and generating a digital object identifier, DOI, of the manufactured component based on the detected salient microfeatures.

According to an embodiment the component is additively manufactured and/or said manufacturing of the component comprises additively manufacturing the component.

It is to be understood that the terminology used by the skilled person is or corresponds to the terminology used in standards such as ASTM F2792.

According to an embodiment, manufacturing the component, in particular additively manufacturing the component comprises a local heating of a feedstock powder or its binder.

According to an embodiment the local heating of the feedstock powder and its binder is carried out by an energy beam, i.e. by an electromagnetic beam of a wavelength in a range between 200 nm and 11000 nm, favorably between 355 nm and 1100 nm or electron beams with an energy of some kV or some 10 kV.

According to an embodiment the energy beam is a light beam, in particular a Laser beam, and/or an electron-beam.

According to an embodiment the feedstock powder comprises at least one of: a metal, a metal oxide, a metal alloy, a mineral, a ceramic, a glass, and a polymer.

According to an embodiment additively manufacturing is selected from: a powder bed fusion (LPBF), a selective Laser Melting (SLM), a selective Laser sintering (SLS), an electron beam melting (EBM), and a direct metal Laser sintering (DMLS); a binder jetting or a material jetting technique used with particles comprising a metal, a metal alloy, a metal oxide, a ceramic, a glass and a polymer; a material extrusion technique, comprising a continuous deposition of the extruded material which is typically a polymer, e.g. a particle filled polymer, or a glass; and a wire arc melting technique, comprising a metal melting in an electric arc.

According to an embodiment additive manufacturing comprises a guiding i.e., an oriented directing said energy beam along a track on a surface of a feedstock powder onto the surface. The surface may typically be a surface of the powder bed, also called feedstock powder. The beam impingement causes at least one of: a softening, a bonding, an adhesion, an aggregating, a sintering, a melting, and an evaporating of adjacent powder particles, the energy beam is directed toward.

According to an embodiment the salient microfeatures of the component are detected non-destructively.

According to an embodiment detecting the salient microfeatures of the component comprises obtaining digital image data of the component, in particular non-destructively obtaining the digital image data of the component, non-destructively obtaining the digital image data of the component. Typically that comprises at least one of: non-destructive imaging, in particular magnetic imaging, optical imaging such as infrared, IR, imaging, ultra-sound imaging or X-ray imaging. Particularly, respective non-destructive 3D-imaging can be used such as a computer tomography, CT, in particular an optical CT such as an IR CT, an X-ray CT or an ultrasound CT.

According to an embodiment the salient microfeatures of the component are detected during manufacturing the component, in particular comprising layer-wise imaging during additively manufacturing the component. In addition, or instead of, i.e. alternatively, imaging may be done immediately after manufacturing the component, in particular after an optional post-treatment process of the manufacturing, typically used at least when the component is additively manufactured, the post-treatment process typically comprising surface polishing and/or heat soaking to release internal stresses and/or settle the microfeatures.

According to an embodiment detecting the salient microfeatures of the component comprises selecting, based on a characteristic of the manufacturing the component, at least one sub-region for detecting the salient microfeatures of the component. Said characteristic may alternatively be considered as manufacturing characteristic.

According to an embodiment detecting the salient microfeatures of the component comprises selectively searching for the salient microfeatures of the component in the at least one sub-region.

According to an embodiment manufacturing, in particular additively manufacturing comprises at least one of: generating a CAD-file at least defining a surface geometry of the component to be manufactured, and using the CAD-file to determine a path of a manufacturing tool, in particular a path of the energy beam such as the Laser-beam and/or to determine a 3D printer slicer file.

According to an embodiment at least one of the CAD-file and the 3D printer slicer file is used to determine the characteristic of the manufacturing the component and/or to select the at least one sub-region.

According to an embodiment the characteristic of manufacturing the component increases a probability of forming salient microfeatures during the manufacturing.

According to an embodiment the characteristic of manufacturing the component results in a locally increased energy transfer during manufacturing the component. For example due to an extended effective dwell time of the energy beam at or close to turning points along the path of the energy beam, also referred to as track of the energy beam, microfeatures are known to be formed with a much higher probability.

According to an embodiment detecting the salient microfeatures comprises optically determining a surface of the manufactured component, in particular a surface contour of the manufactured component and wherein selecting the at least one sub-region is determined based on the optically determined surface.

According to an embodiment the fabrication process comprises at least substantially aligning and/or correlating the optically determined surface and the surface geometry of the component defined by the CAD-file.

According to an embodiment in the fabrication process the step of detecting the salient microfeatures of the component is performed until a given statistical security for the uniqueness of the DOI and/or and given reliability of the DOI for a given detection accuracy of a later non-destructively detecting of the salient microfeatures is achieved, and/or a number/count of salient microfeatures is obtained comprising at least 5, more typically at least 10, and even more typically at least 20, and/or typically at most 30.

According to an embodiment, the suggested fabrication process further includes generating a digital product passport for the manufactured component. Therein, the digital product passport comprising the DOI, typically the digital product passport further comprises at least one of: the CAD-file, the 3D printer slicer file, and additional manufacturing information such as a material information and information regarding the performed detecting of the salient microfeatures of the component. Further, the fabrication process may comprise a step of storing at least one of the DOI and the digital product passport in a database. Further, the fabrication process may include storing at least one of the DOI and the digital product passport in a database

As to the detecting described in embodiments above, said detecting the salient microfeatures of the component comprises at least one of: searching, identifying and detecting. The searching for microfeatures may be performed by searching in the digital image data of the component. The microfeatures (non-destructively) sought for are typically selected from:
i) a microstructure selected from: a void, a pore, a crack, a density inhomogeneity, an inclusion, a region with a density different from the main phase of the component, and
ii) a crystallographic structure selected from: a grain comprising a crystallographic symmetry form such as cubic, tetragonal, trigonal, hexagonal or orthorhombic; an intermetallic phase; and a monocrystalline region.
Identifying the microfeatures may be performed in the digital image data of the component as well. Said detecting may reveal at least one respective parameter of the identified microfeatures (f).

According to an embodiment generating the DOI comprises at least one of: determining coordinates of the identified microfeatures (f); generating the DOI based on the coordinates of the identified microfeatures (f), and generating the DOI based on the at least one respective parameter of the identified microfeatures (f), and generating the DOI based on the surface of the manufactured component.

According to an embodiment, an inspection process includes non-destructively detecting salient microfeatures of a manufactured component; checking an authenticity of the manufactured component based on the non-destructively detected salient microfeatures and a primary digital object identifier, DOI, of the manufactured component. Herein, as briefly mentioned above, the primary DOI is typically a pre-existing DOI.

According to an embodiment and as further explained above and below, the manufactured component is an additively manufactured component.

According to an embodiment the manufactured component's primary DOI is generated in a fabrication process in accordance with any of the embodiments related to the fabrication process as explained herein. Further, the component is typically fabricated using a fabrication process as explained herein.

According to an embodiment of the suggested inspection process, the non-destructively detecting the salient microfeatures of the component includes:
selecting, based on at least one of: the primary DOI, a digital product passport comprising the primary DOI, a characteristic of the manufacturing the component, and a CAD-file at least defining a surface geometry of the component for manufacturing, at least one sub-region of the component for detecting the salient microfeatures of the component, and
selectively searching for the salient microfeatures of the component in the at least one sub-region.

According to an embodiment said inspection process comprises optically determining a surface of the manufactured component, in particular a surface contour of the manufactured component, and wherein selecting the at least one sub-region of the component is based on the optically determined surface.

According to an embodiment said selecting the at least one sub-region comprises at least substantially aligning and/or correlating the optically determined surface and the surface geometry of the component defined by the CAD-file.

According to an embodiment the inspection process comprises: generating a secondary DOI of the manufactured component based on the non-destructively detected salient microfeatures, wherein checking the authenticity comprises comparing the primary DOI and the secondary DOI.

According to an embodiment non-destructively detecting the salient microfeatures of the component comprises at least one of: non-destructive imaging, in particular optical imaging such as infrared, IR, imaging, ultra-sound imaging or X-ray imaging, more particular respective non-destructive 3D-imaging such as a computer tomography, CT, in particular an optical CT such as an IR CT, an X-ray CT or an ultrasound CT.

According to an embodiment any of the suggested inspection processes according to the above embodiments may further encompass at least one of:
retrieving the primary DOI from a database in accordance with a name and/or a product number of the component (c), a picture of the component (c), a fabrication date of the component (c), a lot-number of a material used for manufacturing the component (c), a name and/or number of a customer which uses the component (c), and
searching in the database for a DOI at least substantially matching with the secondary DOI.

According to an embodiment a process e.g. for restoring of a functionality of a component is suggested. The process comprises the process steps of: performing an inspection process as suggested herein, and, if the authenticity is established typically based on the DOI, the process further comprises at least one of: using the component, repairing the component, refurbishing the component, servicing the component, and recycling the component.

According to an embodiment of the suggested process for restoring the functionality, the manufactured component is an additively manufactured component.

According to an embodiment a system is suggested. The system comprises:
a detection sub-system for non-destructively detecting salient microfeatures during manufacturing a component and/or of the manufactured component;
a control unit functionally connected with the detection sub-system and configured for at least one of: checking an authenticity of the manufactured component based on the non-destructively detected salient microfeatures and a digital object identifier, DOI, of the manufactured component, the DOI referring to salient microfeatures of the manufactured component, generating a DOI representing a plurality of the non-destructively detected salient microfeatures.

According to an embodiment the detection subsystem comprises at least one of: a magnetic imaging system, an optical imaging system such as an infrared, IR, imaging system, an ultra-sound imaging system and an X-ray imaging system, more particular a respective non-destructive 3D-imaging system such as a computer tomography, CT, in particular an optical CT such as an IR CT, an X-ray CT or an ultrasound CT.

According to an embodiment the suggested system further comprises an optical detecting sub-system which is functionally connected with the control unit and which is configured to determine a surface of the manufactured component, in particular a surface contour of the manufactured component.

According to an embodiment the optical detecting sub-system comprises a 3D-scanner, and/or the optical detecting sub-system and the detection sub-system are arranged in a defined positional relationship with respect to each other, for example in a working area or working space of the system.

According to an embodiment the control unit is configured to control an inspection process in accordance with any of the embodiments related thereto and suggested above.

According to an embodiment the suggested above system comprises a manufacturing sub-system functionally connected with the control unit and configured for controlling the manufacturing of the component, e.g. as suggested and further described herein.

According to an embodiment the suggested manufacturing sub-system is configured to at least partially additively manufacture the component, wherein the manufacturing sub-system comprises an energy beam source such as a light source, in particular a Laser, and/or an electron-beam source, and/or wherein the manufacturing sub-system comprises a 3D-printer.

According to an embodiment, the control unit functionally connected with the manufacturing system is configured to control the manufacturing sub-system and the detection subsystem such that the manufacturing of the component comprises a layer-by-layer deposition and the detection subsystem provides, during the manufacturing, layer-wise images and/or layer-wise detected salient microfeatures. Therein the control unit is configured to generate the DOI based on the layer-wise images and/or the layer-wise detected salient microfeatures.

According to typical examples, a method for of generating a digital object identifier of a component is suggested. The method comprises:
obtaining digital image data of the component either by using a digital 2D- or 3D-imaging technique or by digitizing an analogue image, e.g. a radiographic film, wherein the component is produced by an additive manufacturing process;
identifying a microfeature within the component in the digital image data of the component;
determining a coordinate, comprising x, y and/or z of the identified microfeature; and
generating the digital object identifier of the component by indicating the coordinate (x, y) or (x, y, z) of the identified microfeatures.

Typically, the component is examined radiographically or by computer tomography and the 2D or 3D image data obtained are analyzed. Advantageously, the suggested method can be integrated into a quality control process for additively manufactured components.

According to an example, the (non-destructively detected) microfeature (f) in the suggested method is selected from:
i) features of the microstructure, like e.g. a void, a pore, a crack, a density inhomogeneity, an inclusion, a region with a density different from the main phase of the component, and
ii) features of a crystallographic structure, like e.g. a grain with a crystallographic symmetry form such as cubic, tetragonal, trigonal, hexagonal or orthorhombic; an intermetallic phase, and a monocrystalline region.

Advantageously, such microfeatures are present in all additively manufactured components if the spatial resolution of the imaging method is sufficiently high. Therein “sufficiently high” means, that the resolution corresponds to the size of the microfeature and is, e.g., at least ⅕ (one fifth) or a 1/10 (one tenth) the length, depth, or diameter of the microfeature.

According to an example, the suggested method further comprises detecting a parameter characterizing the identified microfeature, selected from: a length, a distance, a diameter, a surface, a volume, a grey value, and a surface roughness; wherein the indicated coordinates x, y and/or z characterize a numerical center of the microfeature—e.g. a center of gravity of the microfeature, wherein generating the digital object identifier comprises identifying at least 10, preferably at least 100 microfeatures and arranging, e.g. listing, at least ten of the detected parameters for each identified microfeature in a matrix, such as e.g. a table, wherein the matrix is the digital object identifier.

Advantageously, the form of a matrix or table allows for a conversion into different machine-readable formats like QR code or alphanumeric strings, but presents one of the shortest ways the information about the microstructure obtained using method [10] can be stored.

According to an example, the digital image data are generated during the additive manufacturing process. For instance, they are generated in parallel, i.e. simultaneously, as a measure of in-process monitoring by recording and storing a sequence of 2D images, taken at different times of the manufacturing process. Typically, for a layer-based additive manufacturing digital images or frames of different layers of the component during its layer by layer fabrication are recorded.

While typically the ready manufactured component is examined radiographically or by computed tomography and the 2D or 3D images obtained are analyzed, digital image data can alternatively be obtained already during the manufacturing process of the component. Advantageously, generating the data during the production of the components saves time in the quality control steps after the production, as the data are available together with the component.

According to an example, the suggested method further comprises defining a range for the parameter, wherein only salient/individual internal microfeatures falling within the range are used for generating the digital object identifier.

Advantageously, defining a range for the parameters allows to save data needed to construct the digital object identifier by concentrating on the most relevant microfeatures.

According to an example, a number n of identified microfeatures f is reduced from a total number N of identified microfeatures f to n=1-1000, preferably to n=10-100 by applying the range defined above, more preferably 10-30.

It should be borne in mind that a typical CT dataset will contain X·Y·Z elements, i.e. approximately about 2000·2000·2000=8·10⁹ elements, i.e. 8·10⁹ different voxels. Even if only 10 different randomly distributed microfeatures (e.g. pores) are assumed for a given component, their individual arrangement yields sufficiently different patterns for a myriad of components. In view thereof, advantageously, using preferably 10 to 100 microfeatures gives statistical security for the uniqueness of the digital identifier, while at the same time the identifier is slightly overdetermined, such that in case of loss of a region of the physical part, one would still be able to reconstruct the identifier. Therefore, a number of microfeatures within the range of 10 to 30 represents a good compromise of measurement effort (time) and reliability of the DOI generated from it.

According to an example, the range is selected from a range for a diameter d, a length l, or a thickness t, wherein the length l, the diameter d, and the thickness t is selected within the range of:

$$0.001 mm \leq d \leq 2 mm ; preferably 0.005 mm \leq d \leq 2 mm ;$$

$$0.001 mm \leq l \leq 2 mm ; and$$

$$0.001 mm \leq t \leq 2 mm .$$

Advantageously, this range of microfeature sizes are typical for additively manufactured components produced, e.g., by one of: a powder bed fusion (LPBF) technique or a variation thereof, like Selective Laser Melting (SLM), Selective Laser Sintering (SLS), Electron Beam Melting (EBM) and Direct Metal Laser Sintering (DMLS), which are all applied to a layer or a bed comprising metal and/or ceramic particles; a binder jetting or a material jetting technique used with particles comprising a polymer, a ceramic, or a metal; a material extrusion technique in which a material is drawn through an optionally heated nozzle, comprising a continuous deposition of the extruded material; and a wire arc melting technique, comprising a metal melting in an electric arc.

The present application is focused on generation and use of digital object identifiers for components that are additively manufactured by local heating of the feedstock powder or its binder by, e.g., a laser, such as in:
selective laser melting of a metallic and/or ceramic powder,
selective laser sintering metallic and/or ceramic powder, and
laser polymerization of polymers or metallic/ceramic suspensions using a polymeric binder.

According to an example, the identified microfeature (f) is a pore and/or an inclusion, and the detected parameter is the volume Vᵢ of the i^{th} pore and/or the volume of the inclusion, wherein generating the digital object identifier comprises detecting and indicating a volume fraction epsilon (E), with epsilon (E)=sum(Vᵢ)/V_{comp} for pores and/or inclusions as a checksum for checking the digital object identifier; wherein sum(Vᵢ) is a total volume of all n pores or all n inclusions within the defined range, and V_{Comp} is the total volume of the component.

Advantageously, such and similar microfeatures are easily to identify using digital photography, radiography, and computed microtomography discussed there as digital 2D and 3D imaging techniques.

According to an example, the x, y and/or (optional) z coordinates of a first identified microfeature relate to a virtual origin, wherein the virtual origin comprises the x, y and/or z coordinates of a second identified microfeature; or the virtual origin comprises a mark, selected from a prominent structure at a contour of the component; wherein the x, y and/or z coordinates of the first identified microfeature indicate a minimum or a maximum extension or distance of the first microfeature to the second microfeature along an x-, an y-, and/or an z-axis, which may be indicated in the tabulated digital object identifier, e.g., as Px1/2, Py1/2, and/or Pz1/2.

Advantageously, a table, i.e. a matrix, is easily readable and allows failure-proof digital methods of data extraction.

According to an example, generating the digital object identifier of the component comprises at least one algebraic operation. Particularly, the characters in the table can be coded or decoded in ASCII and converted into a binary string. The number of possible characters is limited to A . . . Z, a . . . z, 1 . . . 9, additionally special characters can be used. The usable ASCII code range, defined in ISO 8859-1, includes the values from 21 h to 7 Eh/33 d to 126d which corresponds 93 characters which can be decoded in binary. It is possible to develop a unique conversion but ASCII is a defined standard which is used. Developing a unique conversion would make only sense if we could decrease the number of bits for conversion.

Advantageously, algebraic operations are robust.

According to an example, the imaging technique is selected from:
a digital radiography, an X-ray computed tomography, an X-ray diffraction, an infrared imaging, e.g. by using an IR camera, e.g. a dual-band IR camera as common in nondestructive testing.

Advantageously, optical tomography can be applied for optically transparent polymers and/or optically transparent or at least translucent ceramics. Wavelength ranges, e.g. within the wavelengths of UV and visible light can be selected depending on the material properties. As to IR-imaging, it is typically used as a 2D in-situ monitoring method during the building process in 3D printing. Despite the rather poor spatial resolution, microstructural features like pores or inclusions can be recognized quite well in the 2D and 3D datasets. In this respect, it is proposed according to the invention to use IR data also for the determination of the identifier.

According to an example, the matrix comprises a table encompassing the detected parameters arranged in columns and rows, wherein each column or row characterizes one identified microfeature.

Advantageously, that allows for facilitated digital data processing, e.g. by easily identifying relevant data for further processing. Particularly, the detected features can be sorted in groups and can be easier selected by the algorithm. Furthermore, it is possible that only specific features are considered to create the DOI.

According to an example, the digital object identifier is compressed and is represented by an alphanumeric and/or by a digital string, by a 2D digital code, e.g. a QR code; or by a 3D digital code.

Advantageously, the conversion into a 2d/3d code is associated with a massive reduction of the data. For creating the DOI only the most important features are used for the 2D/3D code.

According to one example, the method further comprises: Generating a database. Therein, the database includes at least one digital object identifier and at least one of the following: a name and/or product and/or catalog number of the component, an image or photograph of the component, e.g., a reduced icon corresponding to the digital image, a date of manufacture of the component, a batch number or lot number of a material used to manufacture the component, a name and/or number of a customer using the component, a number/name/identification of the machine, assembly line, or production line used in manufacturing the component, etc. The QR code is not a pointer or a reference to a database. It's the direct fingerprint of the object or respective a part of the object (DOI). This means, the computed data of the DOI is directly coded in the QR code and can be read out without a database in the background.

The resulting advantages are apparent, as component-relevant data are stored together with the DOI: Information from the database are linked with the 2D/3D code and backtraceable in both directions.

According to an example, a file format of the digital image is selected from a GIF, a TIF, a TIFF, a PNG, and an SVG, and comprises a header with data indicating conditions of image acquisition, e.g. voltage and current of X-ray source, detector type, exposure time, detector resolution, X-ray source, parameters (e.g. current, voltage, distances), objective type for X-ray microscope; ROI, date/time—if applicable. Other, e.g. even proprietary file formats which are characteristic for the CT equipment used or which are generated by a software package used for reconstruction can also be selected.

Advantageously, such file formats are preferred which do not suffer from data loss resulting from compression algorithms during file generation, which rules out, e.g. .jpeg files.

According to an example, the additive manufacturing process for fabricating the component is selected from:
a powder bed fusion (LPBF) technique and its variations Selective Laser Melting (SLM), Selective Laser Sintering (SLS), Electron Beam Melting (EBM) and Direct Metal Laser Sintering (DMLS), which are all applied to a layer or a bed comprising metal and/or ceramic particles;
a binder jetting or a material jetting technique used with particles comprising a polymer, a ceramic, or a metal;
a material extrusion technique in which a material is drawn through an optionally heated nozzle, comprising a continuous deposition of the extruded material; and
a wire arc melting technique, comprising a metal melting in an electric arc.

Advantages are apparent.

According to an example, the use of a digital object identifier for identifying a component as explained herein, wherein the digital object identifier is generated according to any of the embodiments and examples above, and the component is selected from a part which is used in a field selected from: aviation industry, military, aerospace technology, medical technology, reactor and power plant technology, wind turbines, safety related applications, and automotive industry.

Advantages are apparent.

According to an example, the mentioned use comprises an image registration process, wherein the component c is recognized as a previously known component c by a matching of the digital object identifier of the component with an entry of a database comprising a pre-existing digital object identifier which is identical with the digital object identifier of the component; or—alternatively—wherein the component is recognized as a previously unknown component c′ and/or as a counterfeit c′ by a mis-matching of the digital object identifier of the component c′ with entries of the database comprising pre-existing digital object identifiers.

Advantages are apparent.

Each embodiment and example described above may be combined with any other embodiment and example or embodiments and examples unless clearly indicated to the contrary.

Further, the processes, methods, and steps explained herein are typically respective computer-implemented (or at least computer-assisted) processes, methods and steps.

According to an embodiment, a computer program product or a (non-transitory) computer-readable medium includes instructions which, when executed by a computer, in particular a control unit of a system as explained herein, which may (depending on its equipment) also be referred to as a fabrication and/or inspection system, cause the computer and the system, respectively, to carry out any of the processes, methods, and steps as explained herein.

### BRIEF DESCRIPTION OF THE DRAWINGS

FIG. 1 shows schematically the suggested generation process of a unique object identifier DOI.

FIG. 2 illustrates schematically the suggested generation of a DOI based on individual internal microfeatures of a component as described herein.

FIG. 3 represents a flow-chart of the suggested method for obtaining the DOI of a component.

FIG. 4 represents X-ray computed tomography images of additively manufactured steel cylinders.

FIG. 5 represents a flow-chart of a fabrication process according to an embodiment.

FIG. 6 represents a flow-chart of an inspection process according to an embodiment.

FIG. 7 represents a flow-chart of an inspection process according to an embodiment.

FIG. 8 schematically illustrates system according to an embodiment.

FIG. 9 schematically illustrates system according to an embodiment.

FIG. 10 schematically illustrates system according to an embodiment.

FIG. 11 schematically illustrates system according to an embodiment.

FIG. 12 is a schematic overview illustrating the manufacturing of a component and the generation of a component's digital object identifier (DOI) during the manufacturing of the component according to embodiments of fabrication process.

FIG. 13 is a schematic overview illustrating the manufacturing of a component, and the generation of a component's digital object identifier (DOI) during the manufacturing of the component according to embodiments of fabrication process.

FIG. 14 is a schematic overview illustrating manufacturing and inspecting of a component for its authenticity, based on the DOI according to embodiments.

### DETAILED DESCRIPTION

In the following detailed description, reference is made to the accompanying figures, which form a part hereof, and in which are shown by way of illustration specific embodiments and features of the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

As used herein, the term “QR code” does not refer to the trademark “QR code”, but rather to the corresponding technical encryption method, which is freely available. Further, a QR-code is indicated herein merely as an example for a machine-readable two-dimensional code that can be read by image capture. Reference is made to ISO/IEC 18004:2006 which defines the shape of a QR code. Other two-dimensional codes or encryption methods for generating such are known to the skilled person, e.g. two-dimensional bar code, data matrix code, CM code, Aztec code, to name a few.

A QR code is a typical two-dimensional code. An Aztec code is another two-dimensional code. According to embodiments, codes other than two-dimensional codes may be used as compact and machine readable DOI. For example, a three-dimensional digital code may comprise of a two-dimensional digital code composed of similar elements arranged on a planar surface, the elements having different colour or grey values. Further, a three-dimensional digital code may be represented by a real three-dimensional shape, i.e., a solid structure, or a hologram to visualize such.

According to the invention a digital “fingerprint”, i.e. a digital object identifier which is designated herein as DOI and a method for its generation is suggested. The DOI is generated from a pre-existing individual internal microstructure of the component that hence, is linked to the physical component for its entire lifetime. Particularly, the DOI is generated by extracting representative data, e.g., from CT measurements at the component. The DOI comprises data shown exemplarily in Table 1 further below, and can conveniently be converted into broadly used 2D formats like, e.g., a QR code, a data matrix code, or others, depending on the coding capacity which is required for the actual component. In principle, any 2D code that can contain enough data would work.

Thus, for improved machine readability and compactness, the tabulated measurement data comprising individual component characteristics (microfeatures) are translated into a binary code, and finally compressed as a machine-readable code which is typically illegible for a human. Said exclusively machine-readable code is applied to the component, for example in the form of a corresponding QR code. The table on which this compressed form of the digital object identifier is based (i.e. the actual DOI) is preferably created using a character set in accordance with ISO 8859-1. Consequently, all letters, numbers and special characters designated in this standard are available.

Advantageously this results in great flexibility for the description of the microfeatures acquired, e.g., by CT, digital photography, scanning or by extraction from a digitized analogue photograph (picture). The DOI itself is, so to speak, a spreadsheet with the values of about 100 to about 1000 most important microfeatures, while the QR code generated from it is merely an easily readable representation of the same.

To ensure that the component can be repeatedly identified by different CT measurements and/or devices, minimum technical requirements are defined. The fulfilment of at least some of these minimum technical requirements is a prerequisite for a reliable generation of the DOI.

Typical “minimum technical requirements” are, e.g., a minimum bit depth, e.g. 12 to 16 bits (4096 . . . 65535). A bit depth below 12 would comprise too little in gray values. A minimum contrast-to-noise ratio is at least equal to 5 or greater than 5, wherein the contrast exists between an image area depicting a pore, an inclusion, a crack etc.—i.e. the microfeature with respect to an image area depicting a homogeneous base material which is surrounding the microfeature—i.e. the “matrix” in the current image. Thus, the contrast-to-noise ratio (CNR) is used to determine a scan quality. The CNR is similar to the metric signal-to-noise ratio (SNR), but subtracts a term before taking the ratio. This is important when there is a significant bias in an image. A current image may have a high SNR metric, but a low CNR metric. Thus, the contrast-to-noise ratio as used herein is:

$$CNR = \frac{\vert {s}_{f} - {s}_{M} \vert}{{σ}_{0}} \geq 5 \qquad ( 1 )$$

where S_{f} is the signal intensity for the signal producing microfeatures and S_{M} is the signal intensity for the signal producing matrix M in the region of interest, and σₒ is the standard deviation of the pure image noise.

Another minimum technical requirement relates to the voxel size, i.e. an edge length of the three-dimensional “pixels” of the scan. Said minimum (!) edge length is typically defined herein as the largest sample diameter divided by 1000. In general, the voxel size is equal to the field of view divided by the matrix size.

As yet another minimum technical requirement a minimum spatial resolution of the image dataset used for determining the relevant markers of the sample's microstructure may be used. A preferred minimum spatial resolution is at least 0.5 μm-2000 μm, preferably 1 μm-100 am. Indicated resolution values are expressed in μm=micrometer.

Algebraic operations used to calculate the DOI (i.e. the values exemplarily shown in Table 1) are selected to be robust enough to reliably deliver the same result regardless of lifetime (aging/wear) of the component and tomography device used.

The gray value data set of the scan is subjected to a segmentation. For this purpose, e.g.: the following commercial image processing software packages can be used: Avizo/Amira; VG Studio Max; Dragon Fly or ImageJ/Fiji. These perform the image segmentation step using different algorithms, e.g.:
a. Histogram-based methods, e.g. by determining a threshold value in the histogram;
b. Edge based algorithms, e.g. watershed transformation (Watershed algorithm);
c. Region-based methods such as region growing.

If the data set is available as a binary data set after segmentation (“material”/“no material”), the features can be measured (e.g. a position and/or a volume be determined) and the table entries of the Digital Object Identifier (DOI) as exemplarily shown in Tab. 1 are derived.

Thus, standard segmentation routes and/or algorithms implemented by these or other software packages, like histogram thresholding, region-based segmentation or edge detection segmentation, can favorably be used to segment the relevant markers and to extract their geometrical properties from image data, like shown in Table 1.

The process steps up to this point describe the generation of the DOI.

Under certain conditions, e.g. if at least the minimum technical requirements mentioned above are fulfilled, the DOI of the component can already be created from a part of the data of a complete CT scan, wherein the part of data comprises a subset of all available data representing the unique internal microstructure of the component. Expressed in other words: Typically, the total number N of microfeatures f₁ through f_{N} of a component is too large to be used for DOI generation.

Surprisingly, even a reduced set of microfeatures f₁ through fₙ, wherein n<<N is sufficient to create the DOI. Therefore, according to the invention, the time and costs for generating a really unique and individual DOI of a given component can greatly be reduced. The generated DOI allows for reproducible and/or reliable component identification.

Advantageously, the generation of a series of 2D image data, like radiographs or a series of infrared images taken during the production of the additively manufactured component, is much less time-consuming, as the data set can be created in a fraction of the acquisition time and data volume of a 3D tomographic data set. Even if this advantage is bought with a lower information gain, this is nevertheless predestined for industry-related applications, since the technology required is cheaper and requires less processing manpower than full 3D methods like a complete X-ray tomography of the component. Thus, according to the invention, 2D data for the calculation of the digital identifier can easily be obtained from a given 3D data set, independently from the penetrating wave used for the tomography.

Once a DOI has been generated for a component, this DOI can advantageously be used to identify the component during its lifetime, e.g. during or prior to a service inspection. Also, the DOI can be used for verification during delivery, e.g. within a complex production cycle of a machine to which the component belongs.

For this purpose, it is suggested to create a database, wherein the database comprises records correlating a given digital object identifier (DOI) with at least one of: a name and/or a product or catalogue number of the component, an image of the component, e.g. a reduced symbol corresponding to a photograph or a scan/digital image of the component, a date of manufacture of the component, a batch number of a material used for the manufacture of the component, a name and/or a number of a customer who has purchased or uses the component.

Thus, the later reassignment of a component to a database of existing DOIs, i.e. the “recognition of the DOI”, or the “identification of a component” requires:
Creating the DOI of the component using the process steps described above; and
Registering the segmented record generated from the DOI with the records of the database until a match is found.

Therein, the process of registering or image registration is the process of transforming different sets of data into one coordinate system, as used, e.g., for comparing multiple photographs, data from different sensors, times, depths, or viewpoints, in computer vision, medical imaging, or military automatic target recognition (cf. e.g.: Wikipedia-entry “Image registration”.

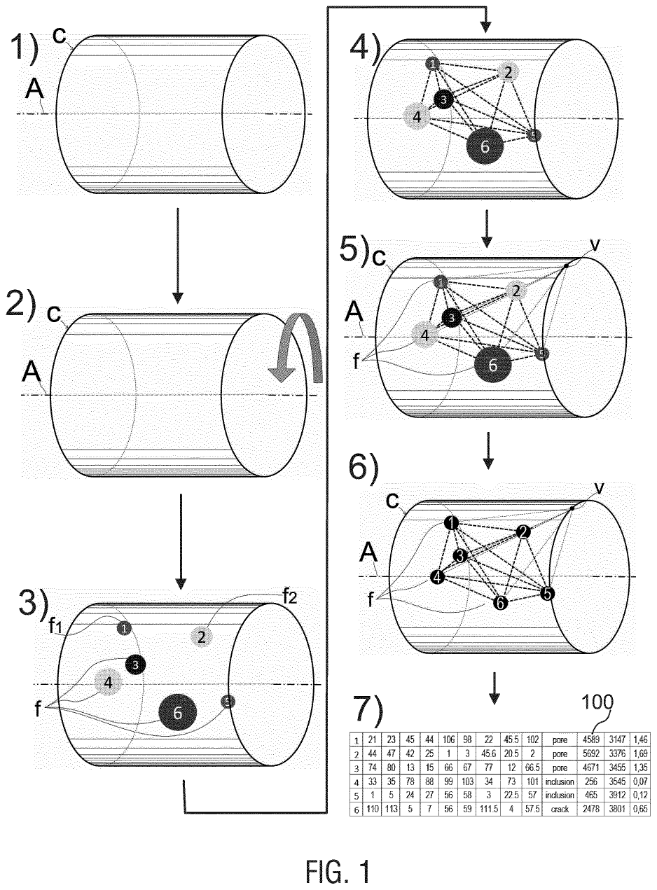

The suggested DOI and its generation is illustrated by attached FIGS. 1-4.

FIG. 1 comprises schemes 1) to 7) and illustrates the proposed process for generating a unique object identifier, i.e., a DOI. Scheme 1) in FIG. 1 shows the provision of component c for which a DOI is to be generated. It should be emphasized that the component c does not have to have a rotationally symmetrical shape like the cylinder in the diagram. However, component c has at least one major axis A or some other spatial feature such as length or diameter. These are advantageously used for a reproducible alignment or arrangement of the component c with respect to an X-ray beam. Examples of corresponding spatial features are e.g. an angle of incidence of the X-ray source in a tomographic measurement, a distance of a component surface to the X-ray source, a spot size of the incident X-ray beam on the component surface.

Thus, according to an embodiment, a surface of the component c may be selected for defining, e.g., a spot size of the incident X-ray beam on a surface of the component c to be set at a defined value. According to an embodiment, a distance between the selected surface of the component c and the X-ray source (bulb) can specifically be set as well to allow for reproducible measurements and acquisition of individual structural microfeatures f1-fn.

In scheme 2) of FIG. 1 a circular arrow on the right side of the component c indicates a rotation of the component c around its main axis A during data acquisition, e.g., with X-ray tomography. The X-ray tomography reveals certain microfeatures f 1-6 that are unique to the given component c. In particular, they are unique with respect to their position, their nature or type, their size, and/or their orientation with respect to the major axis A or with respect to a predefined reference surface, such as a frontal surface (not shown).

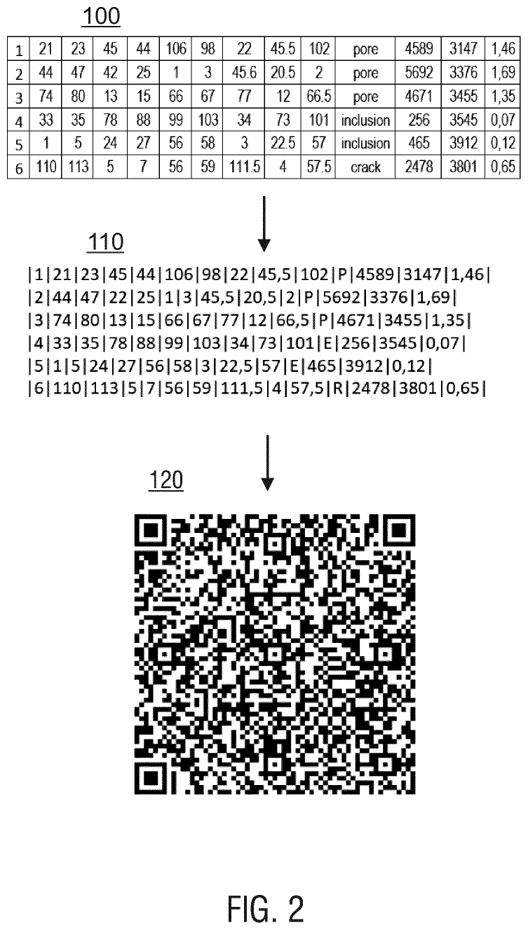

After completing the CT, a data set the size of typically some Terabyte is acquired. Of the whole data set merely some kilobyte are extracted by digital image processing comprising data segmentation and 3D reconstruction. Segmentation and 3D reconstruction finally allow the recognition, i.e. identification of the types of internal structural microfeatures (in FIGS. 1 and 2: f1 through f6). The type, characteristics and position of these internal or component-inherent microfeatures f, are hidden to an observer, inspecting the component c visually. Depending on the actual wealth of available microfeatures f1-fn, in order to reduce the volume of data to be processed for DOI generation, a selection process is applied. According to an embodiment, first the types of available salient microfeatures of the component are detected. Typical types of salient microfeatures are pores, irregularities, inclusions and the like. All types are caused during the additive manufacturing of the component. Their occurrence may depend, e.g., from voids in a wire used in an arc melting technique. They might also be caused, e.g., by a variation of a wettability, e.g. during a binder jetting, if such is used during the additive manufacturing. Further, they might be caused by an electrostatic charging of a powder used in a powder-based manufacturing. Thus, scheme 3) of FIG. 1 shows merely those six microfeatures f1-f6 used to generate a DOI of the actual component c.

Once the microfeatures f are selected for DOI generation, their characteristics are determined. scheme 4) in FIG. 1 illustrates the process of correlating the individual positions (x, y, z) of microfeatures f1-f6 with each other, schematically indicated by bold dotted lines.

Optionally, a reference point v or marker v, i.e. one or a few reference point(s) which are here designated as virtual reference point(s) v, can be defined on the component for better identification and registration as described below. The reference point v can be used as a virtual coordinate origin to which the x, y and z coordinates refer.

According to an embodiment a functionally edge of a component's contour or a recess in a component's surface can be selected as marker v. Reference of microfeatures f₁-f6 with respect to a virtual reference point v is illustrated by thin dotted lines in scheme 5) of FIG. 1.

Scheme 6) of FIG. 1 illustrates the transfer of obtained structural data to a digital position model, wherein specific characteristics are digitally assigned to a position of each feature. All or selected microfeatures are transferred to a matrix, e.g. a table, as shown in scheme 7) of FIG. 1 and illustrated in Tab. 1 below.

In particular, the microfeatures f are analyzed with respect to their position in the dataset (x,y,z), their geometrical properties like, e.g. their volume (voxel size) and to their type. A microfeature f can be further characterized by its voxel size (volume). The position of the feature can be given using different definitions, for example by using the gravitational center of mass of the feature, or the minimum and maximum extension of the microfeature along the x-, y-, and z-axis, respectively. Another option would be to find the smallest sphere that encloses the entire feature and use the sphere's center coordinate as a representation for the position of the feature. Therein, the volume is indicated in a number of voxels comprising the microfeature, wherein a size or volume of the voxel is the same for each voxel of the current measurement. In order to determine the type of feature, its representative gray values needs to be compared to the of the feature's immediate surrounding. This can be carried out by comparing the gray value which is measured for a microfeature f at the gravitational center of the volume, with the one at a distance from its furthest extension in x, y or z. (e.g. +20 pixels), and additionally a ratio of the corresponding values can be specified in a matrix or table, wherein the matrix or table is the very embodiment of the DOI. The coordinates are indicated in pixels. These do not have to be integers and usually are not, e.g., x=23,7, y=118,5, z=20.

FIG. 2 schematically illustrates the conversion of the full, tabular object identifier 100 into an alphanumeric string 110 representing the same in a more compact form, as proposed in accordance with the present invention. As described above, the alphanumeric string 110 containing compressed data of selected internal structural microfeatures f may be converted into a two-dimensional digital code 120, such as the QR code shown. Said 2D code represents the DOI and is thus an equivalent embodiment of the same, just in a compressed and more easily machine-readable form.

As described above, the microfeatures f are typically obtained by computed tomography. However, according to embodiments, they even may be observed and recorded during the additive manufacturing of the component itself.

In particular, they can be obtained for only some selected manufacturing steps, e.g., by optical detection with a CCD image sensor, a digital camera, or an optical scanner during or after a selected manufacturing step, before a subsequent layer of the component material is applied.

If the additive manufacturing of the component comprises a layer-by-layer deposition, or is controlled by a slicing software, images of subsequently fabricated layers may be scanned and their characteristic microfeatures f be detected and then be used to create the DOI of the final part c. Advantageously, that allows for reduced measurement time and costs.

Expressed in other words, the suggested DOI of an additively manufactured component c can be generated using a unique set of internal structural microfeatures f1-fn of said component c. The schematic drawings in FIG. 1 illustrates such a set of individual microfeatures f (1 through 6). The microfeatures f1-fn can be extracted not only from CT data, i.e. 3D images of the component, but also from corresponding 2D images, i.e. virtual “slices” of a stack of 2D images. Therein the stack comprises the whole component c or at least a section thereof. By using relative coordinates of the individual microfeatures f with respect to each other or, optionally, to a virtual origin v, the generation of the DOI is performed. It shall be stressed that the use of a virtual origin v is optional, and used here merely for better understanding. Its application could reduce the falsification security as long as it is disposed at the surface of the component, where it could be destroyed during use or, worse, be manipulated.

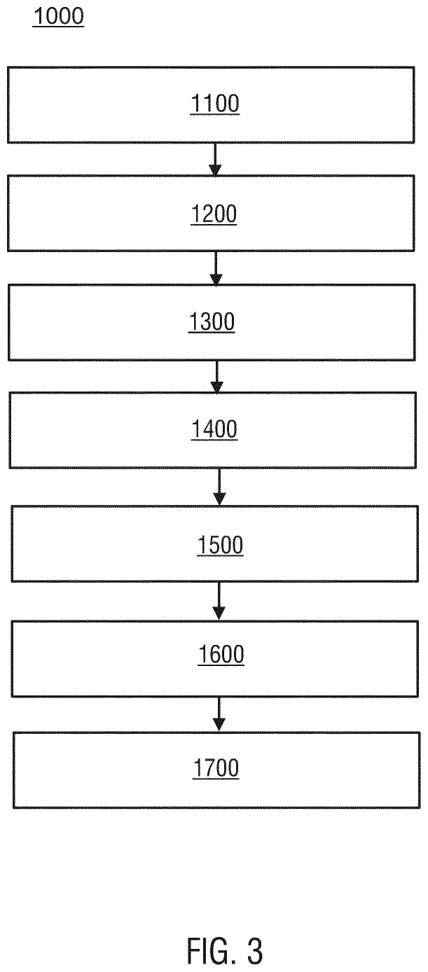

FIG. 3 shows a flow-chart of the described method 1000 for obtaining the individual and unique identifier 100, 110, 120 of a component c, designated according to the invention as DOI of the component.

In particular, according to an embodiment step 1100 comprises providing the component for which a DOI shall be generated. Typically, the suggested method of generating the described digital object identifier is applicable to additively manufactured components. According to an embodiment process step 1100 comprises defining at least an axis, a surface, or an edge of the component which is usable as a reference with respect to which coordinates are designated.

Further, according to the illustrated embodiment step 1200 comprises one of: a scanning, obtaining a digital photography, and performing a computed tomography. It corresponds to scheme 2) of FIG. 1.

Particularly, the scanning may comprise using a scanner, e.g. an image sensor such as a CCD line or CCD array. The scanning may also comprise acquiring photographs or image frames. It is performed for at least five, typically at least 10 different processed layers of an additively manufactured component. Scans or photos might be acquired, e.g., for layers No. 10-15, 25-30, and 35-40, if the component is built-up by a stack of 50 layers in an additive manufacturing process directed by a slicing software, wherein the 50 layers would be layers of the virtually sliced component. Different thereto the minimum number of individual projections for computed tomography is defined, for example, according to ISO 15708 Part 3 as: Minimum number=0.5π·n, i.e. (PI/2)*n, where n is the matrix detector width. This is the number of detector pixels used in the horizontal direction. We always take the complete pixel number of a line here. However, if the line is only half illuminated, this can also be reduced. With 2000 pixels, this results in 3141 minimum projections. With 360°, an odd number of projections must always be achieved, e.g. even by adding some hundred projections—depending on the mechanics and geometry of the CT-apparatus used. A procedure according to the designated standard thus always defines the minimum requirement for a system (apparatus) for computed tomography.

During step 1300 the acquired data are processed by using a digital image processing software which comprises a segmentation and 3D reconstruction. Segmentation is the process of partitioning the acquired digital image into multiple image segments or regions comprising sets of pixels belonging to a certain microfeature f. The goal of the segmentation is to simplify and to ameliorate microfeature analysis. Further, the used 3D reconstruction comprises capturing the shape and appearance of the observed microfeatures f. For example, voids or pores and cracks are recognized as such.

Thereafter, in step 1400 their size (diameter, length) and orientation can be detected and expressed in pixels. Step 1400 corresponds to scheme 4) in FIG. 1.

As explained above, the correlation of the individual positions (x, y, z) of the observed microfeatures f1-fn can be done with respect to a real or virtual marker or reference point v. Its use is symbolized by the method step 1500, which corresponds to the scheme 5) in FIG. 1.

Subsequently, the obtained structural data are transferred into a digital position model, wherein specific characteristics are digitally assigned to a position of each feature. During this step a selection is made of all observed salient structural microfeatures. The selection is made in order to reduce further analysis time and data volume required for DOI generation. The selection process is based on applying specific thresholds for each type of microfeatures. The described step is symbolized by method step 1600, which corresponds to the scheme 6) in FIG. 1.

In the DOI, in principle all microfeatures can be recorded, but for a QR-code representing the DOI their number may have to be reduced to a reasonable number. Optimally starting with the largest features, so that these can also be definitely found again using another imaging system, which may not have as high a resolution as the system with which the first scan (computed tomography scan) was made.

In final step 1700, which corresponds to Scheme 7) of FIG. 1, the data are compiled in a matrix, e.g. a table comprising them is completed. The table (see Table 1) may favorably comprise columns comprising checking values of the used microfeatures. Particularly, the tabular compilation of the microfeatures used can advantageously include a checking value for each individual feature. Said checking value can be used to verify the correctness of the tabular values of the microfeature in question. For example, a cross sum or a quotient of discrete microfeature values can be used as a checking value.

As mentioned above and illustrated by FIG. 2, different representations of the compiled table can be used as DOI: A string 110 as well as a 2D-code, e.g. a QR-code 120.

TABLE 1
Geometrical properties of exemplary microfeatures 1-6 comprising the DOI of a model component.

| | | | | | | | Position data | | | | Grey value | | |
|---|---|---|---|---|---|---|---|---|---|---|---|---|---|
| f | Extension [pixel] | | | | | | center | center | center | | | +20 | |
| (No.) | Px1 | Px2 | Py1 | Py2 | Pz1 | Pz2 | (x) | (y) | (z) | Type | center | px | ratio |
| 1 | 21 | 23 | 45 | 44 | 106 | 98 | 22 | 45.5 | 102 | pore | 4589 | 3147 | 1.46 |
| 2 | 44 | 47 | 42 | 25 | 1 | 3 | 45.6 | 20.5 | 2 | pore | 5692 | 3376 | 1.69 |
| 3 | 74 | 80 | 13 | 15 | 66 | 67 | 77 | 12 | 66.5 | pore | 4671 | 3455 | 1.35 |
| 4 | 33 | 35 | 78 | 88 | 99 | 103 | 34 | 73 | 101 | inclusion | 256 | 3545 | 0.07 |
| 5 | 1 | 5 | 24 | 27 | 56 | 58 | 3 | 22.5 | 57 | inclusion | 465 | 3912 | 0.12 |
| 6 | 110 | 113 | 5 | 7 | 56 | 59 | 111.5 | 4 | 57.5 | crack | 2478 | 3801 | 0.65 |

The pixel positions Px1, Px2, Py1, Py2, Pz1, Pz2 describe the minimum and maximum extension of the microfeature along the x-, y-, and z-axis, respectively. The center coordinates (x), (y), and (z) are the numerical center of gravity of the 3D feature. “Type” denotes the microfeature type, like pore, inclusion, or crack. Grey values at the center coordinates x/y/z of the raw (unsegmented) dataset and its surrounding (e.g. +20 px), as well as their ratio, are given as an indicator for the type of feature. Columns 2-10 are extracted from 3D or 2d imaging data after a segmentation step, whereas columns 11-14 are extracted from the raw, unsegmented data.

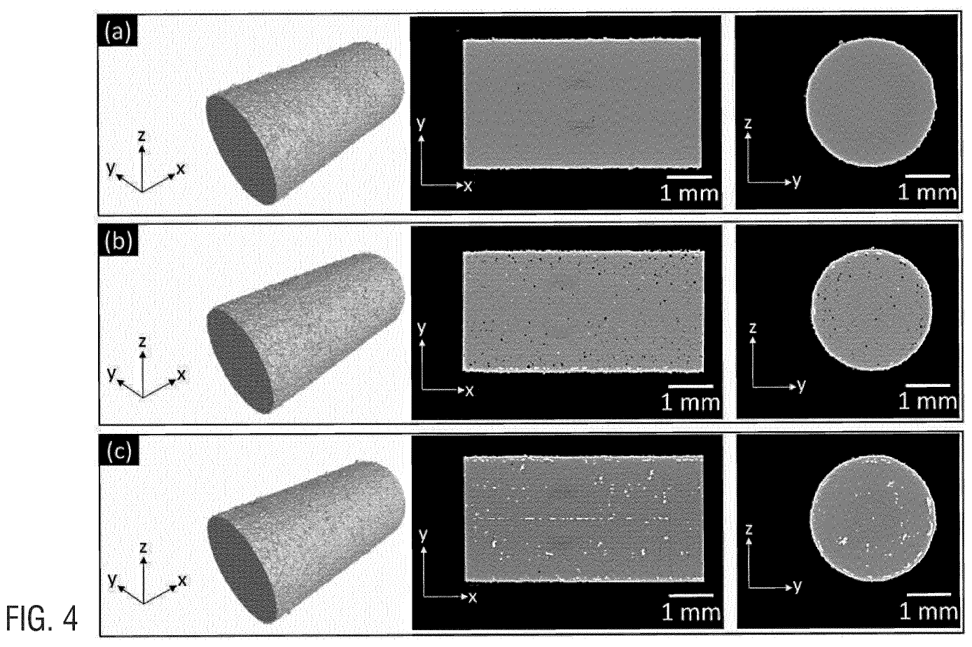

FIG. 4 represents X-ray computed tomography images of additively manufactured 316L steel cylinders reinforced with CeO₂ particles manufactured using the selective laser melting technique. The micrographs show a stochastic distribution in the volume of the component, with different degrees of porosity (black dots) and inclusions (white dots) shown in (a), (b) and (c), and some clustering of pores and inclusions close to the surface and the rotational axis of the cylinder. The figure is taken from O. Salman, A. Funk, A. Waske et al., “Additive Manufacturing of a 316L Steel Matrix Composite Reinforced with CeO2 Particles: Process Optimization by Adjusting the Laser Scanning Speed”, Technologies 2018, 6, 25, which one of the inventors (A. Waske) co-authored.

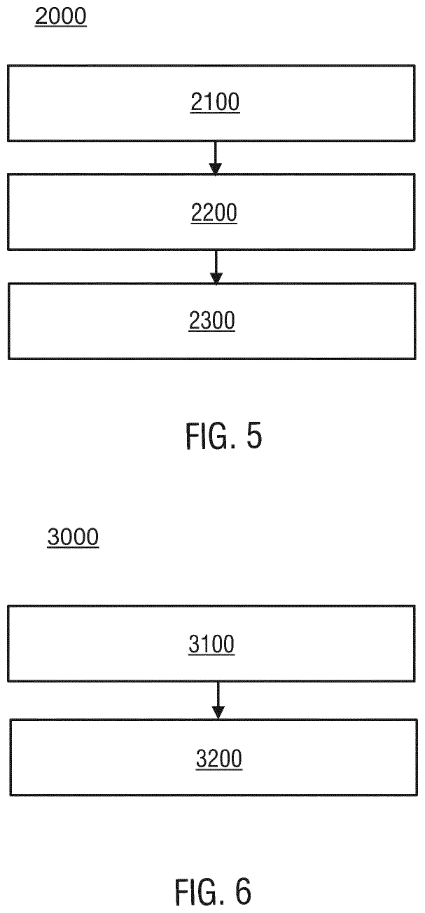

FIG. 5 illustrates a fabrication process 2000 of a component, for example a component c as illustrated in FIG. 1. The fabrication process 2000 may e.g. be carried out by the systems 200″, 200′″ explained below with respect to FIGS. 10, 11.

In a block 2100 of process 2000, the component is manufactured, in particular additively manufactured.

In a block 2200, salient microfeatures of the component are detected.

Block 2200 may be subsequent to block 2100.

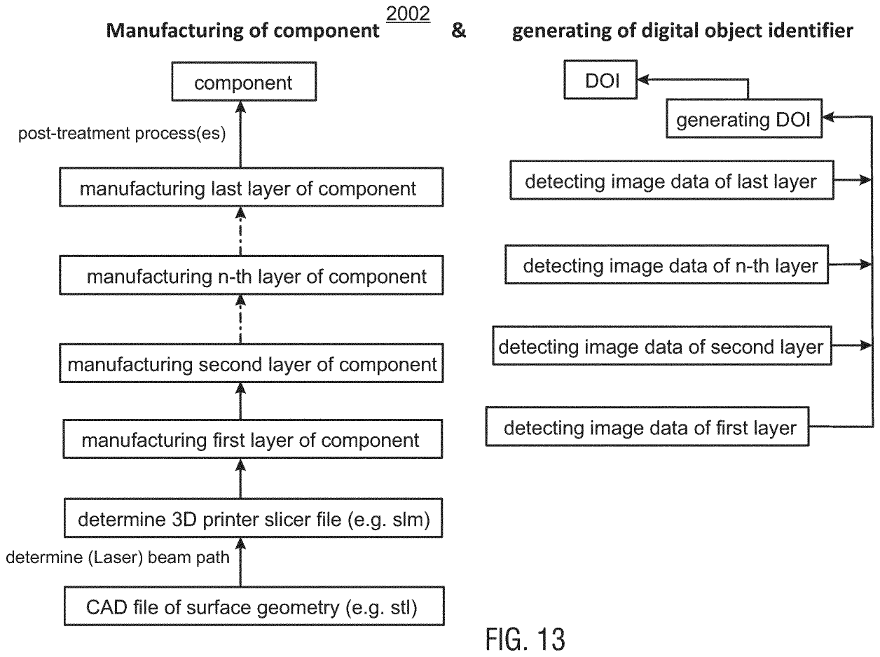

Alternatively, the salient microfeatures of the component may also be detected during manufacturing the component, for example layer-wise. This is explained in more detail below with respect to FIG. 13.

Subsequently, a DOI of the manufactured component may be determined using the detected salient microfeatures, in a block 2300.

The DOI of the component may in particular be determined as explained above, for example as explained with regard to FIGS. 1 to 4.

FIG. 6 represents a flow-chart of an inspection process 3000. The inspection process 3000 may e.g. be carried out by any of the systems 200, 200′ 200″, 200′″ explained below with respect to FIGS. 8 to 11.

In a first block 3100, salient microfeatures of a typically additively manufactured component, for example a component c as illustrated in FIG. 1, are detected.

In a subsequent block 3200, an authenticity of the manufactured component is checked or verified based on the non-destructively detected salient microfeatures and on a primary digital object identifier (DOI) of the manufactured component.

Depending on the result of block 3200, further processes may be carried out.

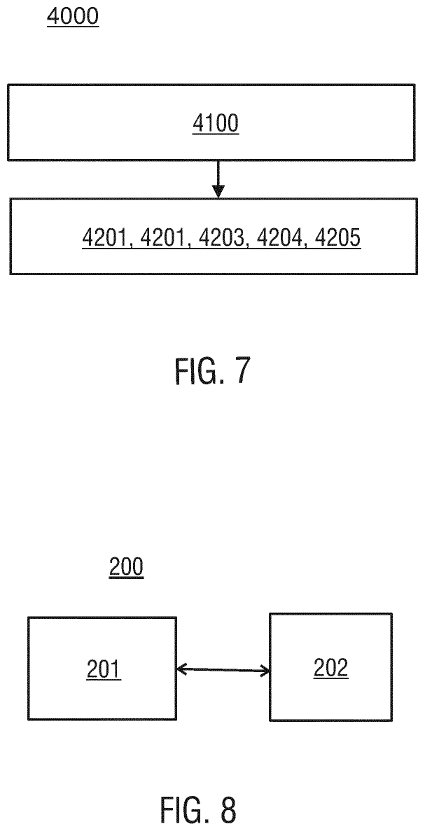

This is explained with regard to FIG. 7 representing a flow chart of a process 4000 that may e.g. be used for restoring of a functionality of a component, typically of an additively manufactured component, for example a component c as illustrated in FIG. 1.

In a first block 4100 an inspection process as explained herein, in particular an inspection process 3000 as explained with regard to FIG. 6 is carried out.

Typically, only if the authenticity of the component is approved in block 3100, at least one of the further processes may be performed:
using (4201) the component, e.g. further using the component as desired such as installing the component (as part of a device or system),
repairing (4202) the component,
refurbishing (4203) the component,
servicing (4203) the component, and
recycling (4201) the component,
   typically in accordance with the DOI, a digital product passport of the manufactured component including the DOI, and/or further information such as a customer request.

As explained above, for cost reasons and reliability of the component—i.e. guarantying a conformity with an applicable (given) standard (such as an ISO standard) it is typically important for a producer (shop, owner of a brand etc.) to repair, refurbish, service and/or recycle only original components (produced by him and under his control).

FIG. 8 shows the typically bidirectional information exchange (arrows) in a system 200 that may perform the inspection processes as explained herein, in particular the inspection process 3000 explained above with respect to FIG. 6, as well as the process for restoring of a functionality of a component such as the process 4000 explained above with respect to FIG. 7. System 200 may be referred to as inspection system.

System 200 has a detection sub-system 201 for non-destructively detecting salient microfeatures, for example of the manufactured component or during the fabrication process of the component, in particular during additively manufacturing the component.

Detection sub-system 201 is typically a non-destructive imaging system, in particular a non-destructive 3D-imaging system.

A control unit 202 of system 200 is functionally connected with the detection sub-system 201 for controlling detection sub-system 201 and receiving results from the detection sub-system 201, in particular image data of the component (during or after manufacturing the component).

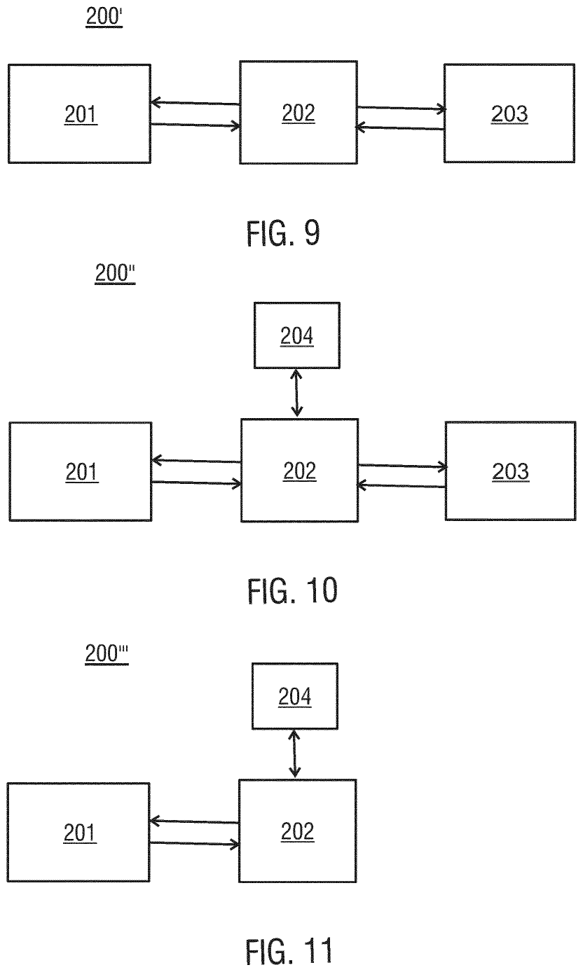

FIG. 9 illustrates a system 200′ which is similar to the system 200 explained above with respect to FIG. 8, but further has an optical detecting sub-system 203 which is functionally connected with the control unit 201.

Optical detecting sub-system 203 may be configured to determine an outer surface of the manufactured component, in particular a respective surface contour of the manufactured component.

In one embodiment, sub-system 203 is a 3D-scanner.

The optical detecting sub-system 203 and the detection sub-system 201 are typically arranged in a defined positional relationship.

FIG. 10 illustrates a system 200″ which is similar to the system 200′ explained above with respect to FIG. 9, but further has a manufacturing sub-system 204 for manufacturing the component, for example a 3D-printer. System 200″ may also be referred to as fabrication system and as a fabrication and inspection system, respectively.

The control unit 201 of system 200″ is functionally connected with the manufacturing sub-system 204.

Furthermore, the control unit 201 may be configured for controlling the manufacturing sub-system 204.

Even further, the control unit 201 is typically configured for controlling the fabrication processes as explained herein, in particular the fabrication process 2000 as explained above with respect to FIG. 5.

In other words, system 200″ is typically configured to perform the fabrication processes as explained herein.

FIG. 11 illustrates a system 200′″ which is similar to the system 200″ explained above with respect to FIG. 10.

However, system 200′″ is not equipped with an optical detecting sub-system that is not required for some of the fabrication processes as explained herein.

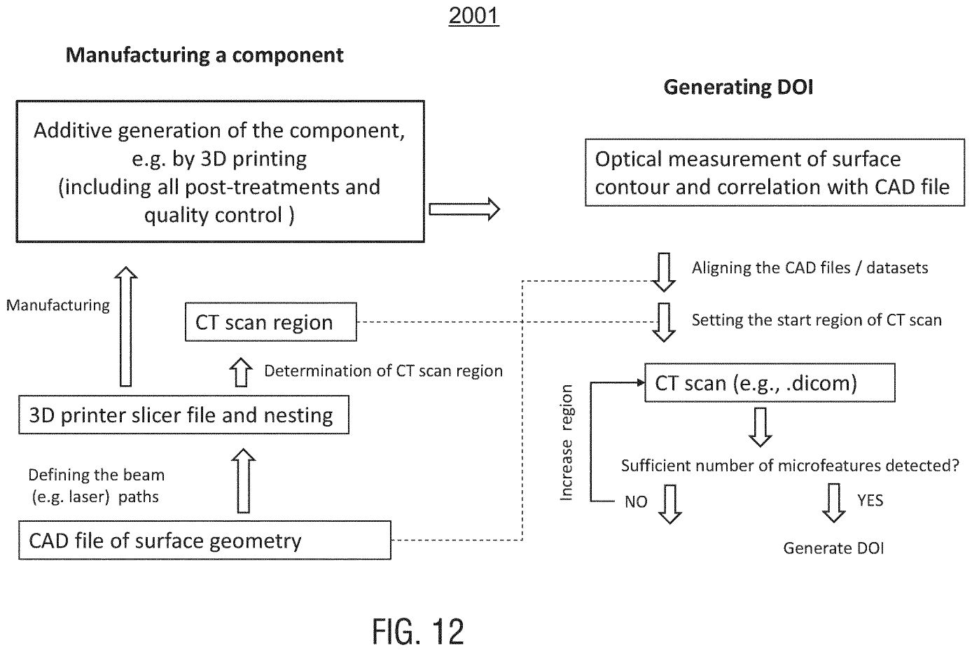

FIG. 12 schematically illustrates a fabrication process 2001 of a component, for example a component as shown in FIG. 1, in particular the manufacturing of the component and the generation of a component's digital object identifier (DOI) during the fabricating of the component and subsequent to the manufacturing.

Fabrication process 2001 is typically similar to fabrication process 2000 explained above with regard to FIG. 5 and also includes the processes of manufacturing the component (block 2100 in FIG. 5) and generating the DOI of the manufactured component based on detected salient microfeatures (blocks 2200, 2300 in FIG. 5).

In the exemplary embodiment shown in FIG. 12, a CAD-file defining a surface geometry of the component to be manufactured is generated.

Thereafter, the CAD-file is used to determine a path of a manufacturing tool, in particular a path of the energy beam such as the Laser-beam or an electron beam, and to generate a 3D printer slicer file.

Between a 3D model provided by the CAD-file (e.g. .stl-file) and the additively manufacturing machine (manufacturing sub-system 204 in FIGS. 10, 11, e.g. a 3D printer), a 3D printing slicer software typically acts as a compiler to prepare an executable 3D model for the 3D printer, in particular by generating a corresponding G-code in the widely used numerical control (NC) programming language.

One way to achieve cost savings and optimize the use of a 3D printer is through nesting, a common step during the data preparation process for 3D printing. Nesting is part of a build preparation stage that optimizes the use of the build volume of a 3D printer. In the nesting process step, the parts are arranged in the build envelope and then sliced all together. Thus, nesting precedes slicing.

Thereafter, the 3D printer slicer file may be executed by the additively manufacturing machine to manufacture the component, i.e. to additively generate the component.

Manufacture the component may include post-treatment processes as well as quality control.

After manufacturing the component, a (primary) DOI may be generated.

In the exemplary embodiment, an outer surface contour of the manufactured component is measured and correlated or even aligned with the surface as defined by the CAD-file used for manufacturing and optional data sets referring to the manufacturing such as G-code files and/or .stl, .dxf, .igs, .stp files.

Furthermore, the 3D printer slicer file is used to determine at least one sub-region (CT scan region) of the manufactured component in which salient microfeatures of the component are likely to have been formed during manufacturing, for example using a CT-scanner.

The at least one sub-region may be used to determine a respective start region for detecting the salient microfeatures (start region of the CT-scan in the exemplary embodiment).

After preforming the detection (CT scan) and detecting salient microfeatures, respectively, the DOI may be generated, if the number and/or characteristics of the so far detected salient microfeatures is considered to be sufficient for a given statistical security of the uniqueness of the DOI and/or and given reliability of the DOI for a given detection accuracy of a later used non-destructively detecting of the salient microfeatures.

Otherwise, the sub-region (CT scan region) may be increased or the detection be performed for another sub-region.

Due to determining the sub-region(s), the detection effort can be reduced considerably.

FIG. 13 schematically illustrates a fabrication process 2002 of a component, for example a component as shown in FIG. 1, in particular the manufacturing of the component and the generation of a component's digital object identifier (DOI) during the manufacturing of the component.

Similar as explained above with respect to FIG. 12, a CAD-file is used to determine a path of a manufacturing tool, in particular a path of the energy beam such as the Laser-beam and to generate a 3D printer slicer file for the component to be additively manufactured, layer-wise in the exemplary embodiment.

During manufacturing the 1^{st} layer of the component and/or (more typically) thereafter, image data of the 1^{st} layer of the component are generated (e.g. detected).

Thereafter, during manufacturing the 2^{nd} layer of the component and/or (more typically) thereafter, image data of the 2^{nd} layer of the component are generated.

The processes of manufacturing the layer and generating corresponding image data are repeated until the last layer.

Thereafter post-treatment processes may be carried out to finish manufacturing.

The detected image data may be used to generate a (primary) DOI of the manufactured component (typically with desired statistical security of the uniqueness of the DOI and/or and given reliability).

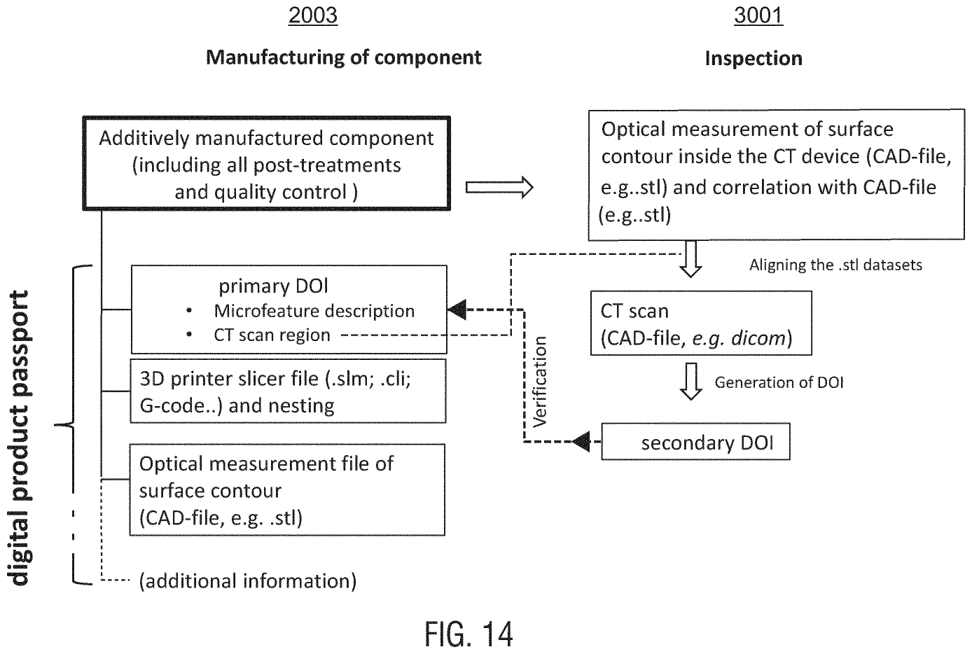

FIG. 14 schematically illustrates a fabrication process 2003 of a component, for example a component as shown in FIG. 1, in particular the manufacturing of the component and the generation of a component's primary digital object identifier (DOI).

Fabrication process 2003 may be similar to fabrication process 2001 explained above with regard to FIG. 12 or fabrication process 2003 explained above with regard to FIG. 12.

For sake of clarity, generating the primary DOI is not shown in FIG. 14.

As shown in FIG. 14, a digital product passport for the manufactured component may be generated in addition.

In the exemplary embodiment, the digital product passport not only includes the DOI, but also the CAD-file, the 3D printer slicer file, and additional manufacturing information such as a material information and information regarding the performed detecting of the salient microfeatures of the component.

The DOI or the digital product passport may be stored in a database.

The stored DOI/digital product passport may later be retrieved from the data base if a later verification/inspection process 3001 is to be carried out.

Inspection process 3001 may be similar to process 3000 explained above with respect to FIG. 6.

Furthermore, the non-destructively detecting of process 3001 may be at least substantially be performed as explained above with regard to FIG. 12, with the exception that a secondary DOI of the previously manufactured component is generated.

The secondary DOI may even be determined using the same system.

After generating the secondary DOI, the first and secondary DOIs may be compared to check and verify, respectively, the authenticity of the manufactured component.

Depending thereon, it may be decided how the manufactured component is handled further, as e.g. explained above with respect to FIG. 7.

The invention can alternatively be described by the aspects listed below:
Use of 2D as well as 3D imaging and diffraction data such as data of digital radiography, computed tomography, X-ray diffraction, infrared imaging, or optical tomography of a component and exploitation of different inspection parameters to highlight salient microfeatures of the component, part, or—generally spoken—sample;
Exploiting natural variations in the microstructure of typically additively manufactured components as a one-to-one digital object identifier or sample marker, even for components generated with identical manufacturing parameters;
Proposed DOIs are applicable mainly for metallic components, but the proposed concept is applicable to other material classes as well, e.g. for ceramics, concrete, polymers;
For pores containing a gas or void pores “containing” a vacuum: Using the center of gravity positions (x, y, z), the minimum/maximum extension along the x/y/z axis (Px1/2, Py1/2, Pz1/2) the equivalent diameter (d), the volumes (V) of a set of individual pores in the additively manufactured workpiece and the total porosity (epsilon=sum(Vᵢ)/V_{component})) as well as the size distribution (N=f(d)), N=f(V), N(f(x), N=f(y), N=f(z));
Therein, the terminus “equivalent spherical diameter” of an irregularly shaped feature is to be understood as the diameter of a sphere with the same volume as the salient microfeature.
Definition of threshold values for size and number of single pores N for calculation of the DOI. A threshold may restrict the used pores to comprise, e.g., only pores with a diameter >5 μm; only the 1000 largest pores, etc.);
For inclusions (solid with a crystallographic or chemical phase deviating from main material/matrix): Using the centroid positions (x, y, z), the diameters (d), the volumes (V) of a set of inclusions in the additively manufactured component and the total volume fraction (epsilon=sum(V)/V_{component})) as well as their size distribution (N=f(d)), N=f(V), N(f(x), N=f(y), N=f(z));
Thresholds can be set for size and number of inclusions N used for generation of the DOI (e.g. only inclusions with d>5 micrometers, only the 1000 largest inclusions, etc.).
For cracks: Use of position, length, and shape of microcracks;
For gray value veiling or density variations: Use of position and shape;
Dimensional deviations inside, conditionally also outside;
Identification and use of certain microfeatures in the component/i.e. of the component, that are typical for the manufacturing facility;
Grain structure, i.e. totality of monocrystalline regions of the component.

CLAUSES of the foregoing comprise:
1. A method (1000) for of generating a digital object identifier (100, 110, 120) of a component (c) comprising:
   obtaining digital image data of the component (c), wherein the component (c) is produced by an additive manufacturing process;
   identifying a microfeature (f) within the component (c) in the digital image data of the component (c);
   determining a coordinate, comprising x, y and/or z; and
   generating the digital object identifier (100) of the component (c) by indicating the coordinate (x, y and or z) of the identified microfeature (f).
2. The method according to clause 1, wherein the microfeature (f) is selected from:
   i) a microstructure selected from: a void, a pore, a crack, a density inhomogeneity, an inclusion, a region with a density different from the main phase of the component, and
   ii) a crystallographic structure selected from: a grain comprising a crystallographic symmetry form such as cubic, tetragonal, trigonal, hexagonal or orthorhombic; an intermetallic phase; and a monocrystalline region.
3. The method according to clause 1 or 2, further comprising:
   detecting a parameter of the identified microfeature (f), selected from: a length, a distance, a diameter, a surface, and a volume, a grey value, and a surface roughness;
wherein the indicated coordinates x, y and/or z characterize a numerical center of the microfeature (f),
wherein generating the digital object identifier comprises identifying at least 10, preferably at least 100 microfeatures (f)
and arranging (e.g. listing) at least three of the detected parameters for each identified microfeature (f) in a matrix (e.g. in a table), wherein the matrix is the digital object identifier (100).
4. The method according to any of clauses 1-3, wherein the digital image data are generated
   during the additive manufacturing process.
5. The method according to any of clauses 1-4, further comprising:
   defining a range for the parameter,
wherein only microfeatures (f) falling within the range are used for generating the digital object identifier (100).
6. The method according to clause 5, wherein a number (n) of identified microfeatures (f) is reduced from a total number (N) of identified microfeatures (f) to a range within
   n=1-1000, preferably to
   n=10-100, more preferably
   n=10-30 by applying the range.
7. The method according to clause 6, wherein the range is selected from a range for a diameter d, a length l, or a thickness t, wherein the length l, the diameter d, and the thickness t is selected within the range of:

$$1 μm \leq d \leq 2 mm ; preferably 5 μm \leq d \leq 2 mm ;$$

$$1 μm \leq l \leq 2 mm ; and$$

$$1 μm \leq t \leq 2 mm .$$

8. The method according to clause 7, wherein the identified microfeature (f) is a pore and/or an inclusion, and the detected parameter is a volume Vᵢ of an i^{th} pore and/or the volume of the Vᵢ of an i^{th} inclusion,
   wherein generating the digital object identifier comprises
      detecting and indicating a volume fraction epsilon (ε), with epsilon (E)=sum(Vᵢ)/V_{comp} for the pore and/or for the inclusion as a checksum for checking the digital object identifier;
   wherein sum(Vᵢ) is a total volume of all n pores or all n inclusions within the defined range, and V_{comp} is the total volume of the component (c).
9. The method according to any of clauses 1 to 8, wherein the x, y and/or z coordinates of a first identified microfeature (f) relate to a virtual origin (v), wherein
   the virtual origin (v) comprises the x, y and/or z coordinates of a second identified microfeature (f); or
   the virtual origin (v) comprises a mark, selected from a prominent structure at a contour of the component (c);
   wherein the x, y and/or z coordinates of the first identified microfeature (f) indicate a minimum or a maximum extension along an x-, an y-, and/or an z-axis.
10. The method according to any of clauses 1 to 9, wherein the imaging technique is selected from:
a digital radiography, an X-ray computed tomography, an X-ray diffraction, and an infrared imaging technique.
11. The method according to any of clauses 3-10, wherein the matrix comprises a table encompassing the detected parameters arranged in columns and rows, wherein each column or row characterizes one identified microfeature (f).
12. The method according to clause 11, wherein the digital object identifier (100, 110, 120) is compressed and is represented by an alphanumeric and/or by a digital string, by a 2D digital code, e.g. a QR code; or by a 3D digital code.
13. The method according to any of clauses 1-12, further comprising:
   generating a database, the database comprising at least one digital object identifier and one of: a name and/or a product number of the component (c), a picture of the component (c), a fabrication date of the component (c), a lot-number of a material used for manufacturing the component (c), a name and/or number of a customer which uses the component (c).
14. The method according to any of clauses 1 to 13, wherein the additive manufacturing process is selected from:
   a powder bed fusion (LPBF) technique and its variations Selective Laser Melting (SLM), Selective Laser Sintering (SLS), Electron Beam Melting (EBM) and Direct Metal Laser Sintering (DMLS), which are all applied to a layer or a bed comprising metal and/or ceramic particles;
   a binder jetting or a material jetting technique used with particles comprising a polymer, a ceramic, or a metal;
   a material extrusion technique, comprising a continuous deposition of the extruded material; and
   a wire arc melting technique, comprising a metal melting in an electric arc.
15. Use of a digital object identifier (100, 120, 130) for identifying a component (c), wherein the digital object identifier (100, 120, 130) is generated according to any of clauses 1 to 14, and the component (c) is selected from a part which is used in a field selected from: aviation industry, military, aerospace technology, medical technology, reactor and power plant technology, wind turbines, safety related applications, and automotive industry.
16. Use according to clause 15 comprising an image registration process, wherein the component (c) is recognized as a previously known component (c) by a matching of the digital object identifier of the component (c) with an entry of a database comprising a pre-existing digital object identifier which is identical with the digital object identifier of the component (c); or—alternatively—wherein the component (c) is recognized as a previously unknown component (c′) and/or as a counterfeit (c′) by a mis-matching of the digital object identifier of the component (c′) with entries of the database comprising pre-existing digital object identifiers.

The present invention has been explained with reference to various illustrative embodiments and examples. These embodiments and examples are not intended to restrict the scope of the invention, which is defined by the claims and their equivalents. As is apparent to one skilled in the art, the embodiments described herein can be implemented in various ways without departing from the scope of what is invented. Various microfeatures, aspects, and functions described in the embodiments can be combined with other embodiments.

1.-42. (canceled)

43. A fabrication process, comprising:
manufacturing a component,
detecting microfeatures of the component, and
generating a digital object identifier (DOI) of the manufactured component based on the detected microfeatures.

44. The fabrication process according to claim 43, wherein manufacturing the component comprises additively manufacturing the component, and wherein the microfeatures are at least one of: microfeatures which are randomly distributed in the component, salient microfeatures, and internal structural microfeatures caused by additively manufacturing the component.

45. The fabrication process according to claim 43, wherein the microfeatures of the component are detected during manufacturing the component by at least one of:
imaging immediately after manufacturing the component,
layer-wise imaging during additively manufacturing the component, and
imaging immediately after additively manufacturing the component following a post-treatment process of the manufacturing selected from the group consisting of surface polishing and heat soaking for at least one of releasing internal stresses and adjusting the microfeatures.

46. The fabrication process according to claim 43, wherein detecting the microfeatures of the component comprises selecting, based on a characteristic of the manufacturing the component, at least one sub-region for detecting the microfeatures of the component, wherein at least one of a CAD-file and a 3D printer slicer file is used to at least one of manufacture the component, determine the characteristic of the manufacturing the component and to select the at least one sub-region, wherein the characteristic of manufacturing the component increases a probability of forming the microfeatures during the manufacturing, wherein the characteristic of manufacturing the component results in a locally increased energy transfer during manufacturing the component, wherein detecting the microfeatures of the component comprises selectively searching for the microfeatures of the component in the at least one sub-region, wherein selecting the at least one sub-region is determined based on an optically determined surface of the manufactured component, wherein the optically determined surface and a surface geometry of the component defined by the CAD-file are at least one of substantially aligned and correlated for selecting the at least one sub-region, and wherein the microfeatures of the component are detected non-destructively.

47. The fabrication process according to claim 43, wherein detecting the microfeatures of the component is performed until at least one of a given statistical security for a uniqueness of the DOI is achieved, a given reliability of the DOI for a given detection accuracy of a later non-destructively detecting of the microfeatures is achieved, and a number of microfeatures used for generating the DOI is at least 5.

48. The fabrication process according to claim 44, wherein additively manufacturing is selected from the group consisting of:
at least one of a powder bed fusion, a selective Laser Melting, a selective Laser sintering, an electron beam melting, and a direct metal Laser sintering;
at least one of a binder jetting and a material jetting technique used with particles comprising at least one of a metal, a metal alloy, a metal oxide, a ceramic, a glass and a polymer;
a material extrusion technique, comprising a continuous deposition of the extruded material; and
a wire arc melting technique, comprising a metal melting in an electric arc.

49. The fabrication process according to claim 43, wherein detecting the microfeatures of the component comprises at least one of:
obtaining digital image data of the component,
non-destructive imaging selected from the group consisting of magnetic imaging, optical imaging, infrared (IR) imaging, ultra-sound imaging, X-ray imaging, non-destructive 3D-imaging, computer tomography (CT), IR CT, X-ray CT, and ultrasound CT, and
searching, in the digital image data of the component, for microfeatures selected from the group consisting of:
i) a microstructure selected from: a void, a pore, a crack, a density inhomogeneity, an inclusion, a region with a density different from the main phase of the component, and
ii) a crystallographic structure selected from: a grain comprising a crystallographic symmetry form including cubic, tetragonal, trigonal, hexagonal and orthorhombic; an intermetallic phase; and a monocrystalline region,
identifying the microfeatures in the digital image data of the component, and
detecting at least one respective parameter of the identified microfeatures.

50. The fabrication process according to claim 43, further comprising at least one of:
generating a digital product passport for the manufactured component, the digital product passport comprising the DOI, the digital product passport further comprising at least one of a CAD-file, a 3D printer slicer file, and additional manufacturing information selected from the group consisting of a material information and information regarding a performed detecting of the microfeatures of the component, and
storing at least one of the DOI and the digital product passport in a database.

51. The fabrication process according to 43, wherein generating the DOI comprises at least one of:
determining coordinates of the detected microfeatures,
generating the DOI based on the coordinates of the detected microfeatures,
generating the DOI based on at least one respective parameter of the detected microfeatures, and
generating the DOI based on a surface of the manufactured component.

52. A process for inspecting a component, comprising:
non-destructively detecting microfeatures of a manufactured component; and
checking an authenticity of the manufactured component based on the non-destructively detected microfeatures and a primary digital object identifier (DOI) of the manufactured component.

53. The process according to claim 52, further comprising at least one of:
retrieving the primary DOI from a database in accordance with at least one of a name of the component, a product number of the component, a picture of the component, a fabrication date of the component, a lot-number of a material used for manufacturing the component, a name of a customer which uses the component, and a number of a customer which uses the component,
generating a secondary DOI of the manufactured component based on the non-destructively detected microfeatures, wherein checking the authenticity comprises comparing the primary DOI and the secondary DOI, and
searching in the database for a DOI at least substantially matching with the secondary DOI.

54. The process according to claim 52, wherein the manufactured component is an additively manufactured component, and wherein the primary DOI is at least one of generated during additively manufacturing the component, based on microfeatures that are non-destructively detected during additively manufacturing the component, and after a post-treatment process selected from the group consisting of surface polishing and heat soaking of the component for at least one of releasing internal stresses and adjusting the microfeatures.

55. The process according to claim 52, wherein non-destructively detecting the microfeatures of the component comprises at least one of:
non-destructive imaging selected from the group consisting of optical imaging, infrared (IR) imaging, ultra-sound imaging, X-ray imaging, non-destructive 3D-imaging, computer tomography (CT), optical CT, IR CT, X-ray CT, and ultrasound CT,
selecting, based on at least one of: the primary DOI, a digital product passport comprising the primary DOI, a characteristic of the manufacturing the component, and a CAD-file at least defining a surface geometry of the component for manufacturing, at least one sub-region of the component for detecting the microfeatures of the component, and
selectively searching for the microfeatures of the component in the at least one sub-region.

56. The process according to claim 52, comprising:
optically determining a surface of the manufactured component including a surface contour of the manufactured component, and
at least one of:
selecting at least one sub-region of the component for detecting the microfeature, wherein selecting the at least one sub-region of the component is based on the optically determined surface, and
selecting at least one sub-region for detecting the microfeature, wherein selecting the at least one sub-region of the component comprises at least one of substantially aligning and correlating the optically determined surface and the surface geometry of the component defined by a CAD-file used for manufacturing.

57. The process according to claim 52, comprising, if the checking of the authenticity of the manufactured component is successful based on the primary DOI, at least one of:
restoring of a functionality of the component,
using the component,
repairing the component,
refurbishing the component,
servicing the component, and
recycling the component.

58. A system, comprising:
a detection sub-system for at least one of non-destructively detecting microfeatures during manufacturing a component and non-destructively detecting microfeatures of the manufactured component; and
a control unit functionally connected with the detection sub-system and configured for at least one of:
checking an authenticity of the manufactured component based on the non-destructively detected microfeatures and a digital object identifier (DOI) of the manufactured component, the DOI referring to microfeatures of the manufactured component, and
generating a DOI representing a plurality of the non-destructively detected microfeatures.

59. The system according to claim 58, wherein the detection subsystem comprises at least one of: a magnetic imaging system, an optical imaging system, an infrared (IR) imaging system, an ultra-sound imaging system an X-ray imaging system, a non-destructive 3D-imaging system, computer tomography (CT) an optical CT, an IR CT, an X-ray CT, and an ultrasound CT.

60. The system according to claim 58, further comprising an optical detecting sub-system functionally connected with the control unit and configured to determine a surface of the manufactured component including a surface contour of the manufactured component, the optical detecting sub-system comprising a 3D-scanner, the optical detecting sub-system and the detection sub-system being arranged in a defined positional relationship.

61. The system according to claim 58, wherein the system comprises a manufacturing sub-system for manufacturing the component, the control unit being functionally connected with the manufacturing sub-system, the control unit being configured for controlling the manufacturing sub-system, wherein the manufacturing sub-system is configured to at least partially additively manufacture the component, wherein the manufacturing sub-system comprises at least one of an energy beam source selected from the group consisting of a light source, a Laser, and an electron-beam source, and a 3D-printer.

62. The system according to claim 61, wherein the control unit is configured to control the manufacturing sub-system and the detection subsystem such that the manufacturing of the component comprises a layer-by-layer deposition and the detection subsystem provides, during the manufacturing, at least one of layer-wise images and layer-wise detected microfeatures, and wherein the control unit is configured to generate the DOI based on at least one of the layer-wise images and the layer-wise detected microfeatures.
